(19) United States
(12) Patent Application Publication
(10) Pub. No.: US 2025/0328144 A1
(43) Pub. Date: Oct. 23, 2025

(54) DEVICE LOCALIZATION AND NAVIGATION USING RF SENSING

(71) Applicant: The Regents of the University of California, Oakland, CA (US)

(72) Inventors: Aditya Arun, San Jose, CA (US); Roshan Ayyalasomayajula, San Diego, CA (US); William Hunter, San Diego, CA (US); Dinesh Bharadia, San Diego, CA (US)

(21) Appl. No.: 18/872,190

(22) PCT Filed: Jun. 8, 2023
(86) PCT No.: PCT/US2023/068106

§ 371 Date: Dec. 5, 2024

Related U.S. Application Data
(60) Provisional application No. 63/350,927, filed on Jun. 10, 2022.

(51) Int. Cl. G05D 1/246; G05D 1/247; G05D 111/10; G05D 111/30; G05D 111/50

(52) U.S. Cl. CPC G05D 1/246; G05D 1/247; G05D 2111/17; G05D 2111/30; G05D 2111/52; G05D 2111/54

(57) ABSTRACT

A robot or other device capable of movement includes a local position module and an RF communication module, the RF communication module being configured to communicate with RF anchor points to conduct one or more of navigation, positioning, exploration, tracking, and mapping. The robot or other device can include a transceiver configured to communicate with fixed location RF anchor points and a relative odometry unit. The robot or other device also can include a localization and navigation system that can conduct bearing measurements, which can be two-way bearing measurements, between the robot and one or more of the RF anchor points and integrates the bearing measurements with odometry measurements to navigate an environment of the RF anchor points.

### PRIORITY CLAIM AND REFERENCE TO RELATED APPLICATION

The application claims priority under 35 U.S.C. § 119 and all applicable statutes and treaties from prior U.S. provisional application Ser. No. 63/350,927, which was filed Jun. 10, 2022.

### FIELD

A field of the invention concerns systems that conduct device locating and environment mapping, including robotics, robotic control, and other movable devices having transceivers located in an environment, for example Internet of Things (IoT) devices. A specific application of the invention concerns indoor robotic systems.

### BACKGROUND

Indoor robots find application in warehouse management, inventory control in retail stores, including supermarkets, and package delivery. Indoor robots use SLAM (simultaneous localization and mapping) systems having visual sensors that work in tandem with on-board odometry or IMU (inertial measurement unit) sensors.

Cameras provide low-cost, feature, and context-rich maps and location estimates but tend to fail in homogeneous feature-limited spaces like long corridors or bad-indoor lighting conditions [2]. LiDARs (light detection and ranging) provide long-range, high-resolution, and relatively more descriptive sensing but are expensive tend to fail in homogeneous feature-limited spaces [3].

Radio-frequency (RF) sensors are robust to dynamic lighting conditions and structured indoor environments and are insensitive to line-of-sight [4]. Example WiFi transceivers are ubiquitously deployed with many fixed access points (APs) and exhibit a SWAP-C(power and cost) [5] metric 10× better than LiDARs [6].

RF-technology implementations based on UWB (ultra wide-band) [7], BLE (Bluetooth low energy) [8], [9], RFID (radio frequency identification) [10], or backscatter devices exist.

WiFi provides a very convenient system to leverage due to its ubiquitous presence in common indoor environments in which indoor robots are useful. Typical WiFi tracking systems require a priori knowledge of locations WiFi APs. The user or robot that carries the WiFi transceiver is localized to previously mapped APs or vice-versa [13]. Such existing systems use a known location of the robot or the AP to locate the other.

Some publications describe limited use of WiFi sensor readings to improve mapping and locating that leverages other sensors. [14]-[17]. WiFi signal strength (RSSI) is leveraged to predict ‘loop closures’ for camera-Lidar-based systems [14], [15]. RSSI has been described to integrate WiFi sensors, but mere RSSI measurements provide ineffective localization. RSSI estimates can vary drastically in dynamic indoor scenarios [12], making them unsuitable metrics for WiFi signals. Traditional algorithms identify the direct signal's path among the multiple reflected paths by ‘super-resolving’ the measured signal. [12]. By using information across N different frequency bins, they measure the relative time offset between different signal paths. [12]. This allows identification of the direct path, as it must have traveled the least distance of all paths and thus arrives before the other reflections. However, the addition of this extra dimension of time-offset adds computation overhead, making them unsuitable for resource-efficient SLAM.

### PRIOR PUBLICATIONS

[1] T. Deyle, “Why indoor robots for commercial spaces are the next big thing in robotics,” IEEE Spectrum, 2017.
[2] X. Deng, Z. Zhang, A. Sintov, J. Huang, and T. Bretl, “Feature-constrained active visual slam for mobile robot navigation,” in 2018 IEEE international conference on robotics and automation (ICRA). IEEE, 2018, pp. 7233-7238.
[3] A. Zhang and M. M. Atia, “Comparison of 2d localization using radar and lidar in long corridors,” in 2020 IEEE Sensors. IEEE, 2020, pp. 1-4.
[4] R. Ayyalasomayajula, A. Arun, C. Wu, S. Sharma, A. R. Sethi, D. Vasisht, and D. Bharadia, “Deep learning based wireless localization for indoor navigation,” in Proceedings of the 26th Annual International Conference on Mobile Computing and Networking, 2020, pp. 1-14.
[5] R. C. Allen, W. B. Blanton, E. Schramm, and R. Mitra, “Strategies for reducing swap-c and complexity in dve sensor systems,” in Degraded Environments: Sensing, Processing, and Display 2017, vol. 10197. International Society for Optics and Photonics, 2017, p. 101970M.
[6] “Hokuyo lidar,” https://autonomoustuff.com/product-category/lidar/hokuyo-laser-scanners/, accessed: 2020 Oct. 31.
[7] T.-M. Nguyen, S. Yuan, M. Cao, T. H. Nguyen, and L. Xie, “Viral slam: Tightly coupled camera-imu-uwb-lidar slam,” arXiv preprint arXiv:2105.03296, 2021.
[8] A. Sato, M. Nakajima, and N. Kohtake, “Rapid ble beacon localization with range-only ekf-slam using beacon interval constraint,” in 2019 International Conference on Indoor Positioning and Indoor Navigation (IPIN). IEEE, 2019, pp. 1-8.
[9] M. G. Jadidi, M. Patel, J. V. Miro, G. Dissanayake, J. Biehl, and A. Girgensohn, “A radio-inertial localization and tracking system with ble beacons prior maps,” in 2018 International Conference on Indoor Positioning and Indoor Navigation (IPIN). IEEE, 2018, pp. 206-212.
[10] Y. Ma, N. Selby, and F. Adib, “Drone relays for battery-free networks,” in Proceedings of the Conference of the ACM Special Interest Group on Data Communication, 2017, pp. 335-347.
[11] S. Zhang, W. Wang, S. Tang, S. Jin, and T. Jiang, “Robot-assisted backscatter localization for iot applications,” IEEE Transactions on Wireless Communications, vol. 19, no. 9, pp. 5807-5818, 2020.
[12] Y. Ma, G. Zhou, and S. Wang, “Wifi sensing with channel state information: A survey,” ACM Computing Surveys (CSUR), vol. 52, no. 3, pp. 1-36, 2019.
[13] R. Ayyalasomayajula, A. Arun, C. Wu, A. Shaikh, S. Rajagopalan, Y. Hu, S. Ganesaraman, C. J. Rossbach, A. Seetharaman, E. Witchel et al., “Locap: Autonomous millimeter accurate mapping of wifi infrastructure,” in 17th {USENIX} Symposium on Networked Systems Design and Implementation ({NSDI} 20), 2020, pp. 1115-1129.
[14] Z. S. Hashemifar, C. Adhivarahan, A. Balakrishnan, and K. Dantu, “Augmenting visual slam with wi-fi sensing for indoor applications,” Autonomous Robots, vol. 43, no. 8, pp. 2245-2260, 2019.
[15] R. Liu, S. H. Marakkalage, M. Padmal, T. Shaganan, C. Yuen, Y. L. Guan, and U.-X. Tan, “Collaborative slam based on wifi fingerprint similarity and motion information,” IEEE Internet of Things Journal, vol. 7, no. 3, pp. 1826-1840, 2019.
[16] J. Huang, D. Millman, M. Quigley, D. Stavens, S. Thrun, and A. Ag-garwal, “Efficient, generalized indoor wifi graphslam,” in 2011 IEEE international conference on robotics and automation. IEEE, 2011, pp. 1038-1043.
[17] B. Ferris, D. Fox, and N. D. Lawrence, “Wifi-slam using gaussian process latent variable models.” in IJCAI, vol. 7, no. 1, 2007, pp. 2480-2485.
[18] M. Kaess, H. Johannsson, R. Roberts, V. Ila, J. J. Leonard, and F. Dellaert, “isam2: Incremental smoothing and mapping using the bayes tree,” The International Journal of Robotics Research, vol. 31, no. 2, pp. 216-235, 2012.
[19] E. Perahia and R. Stacey, Next generation wireless LANs: 802.11 n and 802.11 ac. Cambridge university press, 2013.
[20] Turtlebot 2, Turtlebot Robotics.
[21] “RealSense D415,” 2019, https://www.intel.com/content/dam/support/us/en/documents/emerging-technologies/intel-realsense-technology/Intel-RealSense-D400-Series-Datasheet.pdf.
[22] Quantenna, “Quantenna 802.11ac WiFi Card,” 2018, http://www.quantenna.com/wp-content/uploads/2018/04/QSR10GU-AX-V1.1.pdf.
[23] W. Hess, D. Kohler, H. Rapp, and D. Andor, “Real-time loop closure in 2d lidar slam,” in 2016 IEEE International Conference on Robotics and Automation (ICRA). IEEE, 2016, pp. 1271-1278.
[24] M. Ibrahim, H. Liu, M. Jawahar, V. Nguyen, M. Gruteser, R. Howard, B. Yu, and F. Bai, “Verification: Accuracy evaluation of wifi fine time measurements on an open platform,” in Proceedings of the 24th Annual International Conference on Mobile Computing and Networking, 2018, pp. 417-427.
[25] M. Kotaru, K. Joshi, D. Bharadia, and S. Katti, “SpotFi: Decimeter Level Localization Using Wi-Fi,” ser. SIGCOMM, 2015.
[26] R. G. Gallager, “Circularly-symmetric gaussian random vectors,” preprint, pp. 1-9, 2008.
[27] K. H. Biyari and W. C. Lindsey, “Statistical distributions of hermitian quadratic forms in complex gaussian variables,” IEEE transactions on information theory, vol. 39, no. 3, pp. 1076-1082, 1993.
[28] S. Soltani and M. W. Mutka, “Argmax and argmin: transitional probabilis-tic models in cognitive radio mesh networks,” Wireless Communications and Mobile Computing, vol. 15, no. 9, pp. 1355-1367, 2015.
[29] A. Stuart, J. K. Ord, and S. Arnold, “Kendall's advanced theory of statistics. vol. 2a: Classical inference and the linear model,” Kendall's advanced theory of statistics. Vol. 2A: Classical inference and the linear model, 1999.
[30] G. Grisetti, R. Kummerle, C. Stachniss, and W. Burgard, “A tutorial on graph-based slam,” IEEE Intelligent Transportation Systems Magazine, vol. 2, no. 4, pp. 31-43, 2010.
[31] Z. Zhang, “Parameter estimation techniques: A tutorial with application to conic fitting,” Image and vision Computing, vol. 15, no. 1, pp. 59-76, 1997.
[32] M. Labb′e, “Rtab-map as an open-source lidar and visual slam library for large-scale and long-term online operation,” 2018.
[33] C. Cadena, L. Carlone, H. Carrillo, Y. Latif, D. Scaramuzza, J. Neira, I.Reid, and J. J. Leonard, “Past, present, and future of simultaneous localization and mapping: Toward the robust-perception age,” IEEE Transactions on robotics, vol. 32, no. 6, pp. 1309-1332, 2016.
[34] M. Zhao, T. Chang, A. Arun, R. Ayyalasomayajula, C. Zhang, and D. Bharadia, “Uloc: Low-power, scalable and cm-accurate uwb-tag localization and tracking for indoor applications,” Proceedings of the ACM on Interactive, Mobile, Wearable and Ubiquitous Technologies, vol. 5, no. 3, pp. 1-31, 2021.
[35] R. Ayyalasomayajula, D. Vasisht, and D. Bharadia, “Bloc: Csi-based accurate localization for ble tags,” in Proceedings of the 14th International Conference on emerging Networking Experiments and Technologies, 2018, pp. 126-13
[36] A. B. Pizarro, J. P. Beltrán, M. Cominelli, F. Gringoli, and J. Widmer, “Accurate ubiquitous localization with off-the-shelf ieee 802.11ac devices,” in Proceedings of the 19th Annual International Conference on Mobile Systems, Applications, and Services, ser. MobiSys '21. New York, NY, USA: Association for Computing Machinery, 2021, p. 241-254. [Online]. Available: https://doi.org/10.1145/3458864.3468850
[37] J. Xiong and K. Jamieson, “Secureangle: improving wireless security using angle-of-arrival information,” in Proceedings of the 9th ACM SIGCOMM Workshop on Hot Topics in Networks, 2010, pp. 1-6
[38] N. Jadhav, W. Wang, D. Zhang, S. Kumar, and S. Gil, “Toolbox release: A wifi-based relative bearing framework for robotics,” in 2022 IEEE/RSJ International Conference on Intelligent Robots and Systems (IROS), 2022, pp. 13 714-13 721.
[39] R. Schmidt, “Multiple emitter location and signal parameter estimation,” IEEE Transactions on Antennas and Propagation, vol. 34, no. 3, pp. 276-280, 1986.
[41] D. Halperin, W. Hu, A. Sheth, and D. Wetherall, “Tool release: Gathering 802.11n traces with channel state information,” ACM SIGCOMM Computer Communication Review, vol. 41, no. 1, pp. 53-53, 2011.
[42] Y. Xie, Z. Li, and M. Li, “Precise power delay profiling with commodity wifi,” in Proceedings of the 21 st Annual International Conference on Mobile Computing and Networking, ser. MobiCom '15. New York, NY, USA: ACM, 2015, p. 53-64. [Online]. Available: http://doi.acm.org/10.1145/2789168.2790124
[43] F. Gringoli, M. Schulz, J. Link, and M. Hollick, “Free your csi: A channel state information extraction platform for modern wi-fi chipsets,” in Proceedings of the 13th International Workshop on Wireless Network Testbeds, Experimental Evaluation & Characterization, 2019, pp. 2128.

### SUMMARY OF THE INVENTION

A robot or other device capable of movement includes a local position module and/or an RF communication module to conduct one or more of navigation, positioning, exploration, tracking, and mapping, the RF communication module being configured to communicate with RF anchor points and local the positioning module configured to provide relative odometry measurements. The robot or other device can include a transceiver configured to communicate with fixed location RF anchor points and a relative odometry unit. The robot or other device also can include a localization and navigation system that conducts bearing, distance and/or velocity measurements between the robot and one or more of the RF anchor points and integrates bearing measurements with odometry measurements to navigate an environment of the RF anchor points.

### BRIEF DESCRIPTION OF THE DRAWINGS

FIG. 1 shows a robot with localization and navigation in an access point environment;

FIGS. 2A-2B show a preferred WiFi Robot localization and navigation system;

FIG. 3 shows a preferred dual-graph WiFi Robot localization and navigation system;

FIG. 4 shows a preferred system for guidance of a robot including WiFi Robot localization and navigation;

FIG. 5 shows a robot with localization and navigation in an access point environment with WiFi navigation correction;

FIG. 6 shows a preferred WiFi Robot localization and navigation system; and

FIGS. 7A & 7B illustrate visualizations created in the FIG. 6 system.

### DETAILED DESCRIPTION OF THE PREFERRED EMBODIMENTS

Preferred embodiments integrate WiFi devices, or fixed location devices following another communication standard, as an anchor point to simultaneously locate robot(s) or other mobile devices and map the WiFi access point (APs) as landmarks in an environment. Any WiFi receiver and transmitter can be repurposed via the invention to be used for localization purposes for a robot, or other mobile devices having IMU (inertial measurement unit) sensors. Preferred methods and systems use both WiFi access points deployed in the environment and on the robot(s) to get accurate location of the robot(s) in the environment with the WiFi network(s) extend. Other fixed RF devices, such as IoT devices, e.g. humidity or temperature sensors, can be used as anchor points.

WiFi is preferred as APs are widely installed and tend to have fixed positions. However, other access points and devices can be used. Generally, devices that are uniquely identifiable from a hardware MAC address are suitable for use as landmarks in the context of the invention, when the devices provide initial ping-pong style communications with unknown devices to initialize communications or to notify other devices of their presence. Such initialization or notice communications are all that is needed, and robots need not have credentials, e.g., passwords, for data communications with the APs. Instead, the robots use the initialization or notice communications to map an environment.

Preferred embodiments provide WiFi as a reliable and cost-effective SLAM sensor that requires no-loop closure and can overcome challenging indoor scenarios where cameras and LiDARs tend to fail. Preferred methods simultaneously locate the robot and map the WiFi APs in the environment without a priori knowledge of location of the robot or the APs.

Preferred embodiment systems and methods can identify unique features to extract from the WiFi signals and ensure that they are unambiguous in structured and monotonous indoor environments. The features can be extracted without a priori knowledge of the environment, e.g., a robot having a SLAM system of the invention can lack any knowledge regarding the number of access points or the locations of the access points in an environment. Identified features can be modeled and characterized such that noise and errors in these measurements are accounted for when conducting localization and mapping. Preferred methods and systems readily integrate with odometry measurements into openly available SLAM frameworks and scale to many indoor applications. Applications includes, for example, AR/VR, motion tracking, exploration, navigation, mapping, positioning, localization, and devices that use the invention can be AR/VR headsets, mobile phones, drones, wheeled robot.

A preferred embodiment provides a localization and mapping system which leverages RF transceivers in the environment to provide an accurate trajectory to robots or other devices. An accurate trajectory can be provided via a dual-layered approach, with local trajectory corrections and the global trajectory corrections. The RF receivers can be WiFi devices. Preferred systems integrate WiFi and inertial odometry measurements to achieve globally consistent trajectory estimates. Odometry can come from, for example, visual-inertial odometry or lidar inertial odometry, gyroscopes, or accelerometers. A trajectory provided by the inertial measurement systems of the robot or other device can be the locally corrected trajectory, which is then corrected by global trajectory estimations. RF sensor measurements can be bearing measurements to and/or from the RF transceivers in the environment and the RF sensor on board a robot or other device. The raw RF measurements can include coarse-grained WiFi signal strength (RSSI), fine-grained WiFi channel state information (CSI), and other MAC-layer information. Systems can discover and map RF devices and place the robot or other device in real-time. Use of RF landmarks/anchors can reduce computational load for navigation. The mapping can correct for hardware biases in the RF transceivers. Calibration can consist of phase and magnitude corrections to the received WiFi data. Processing can consist of FFT, SVD-FFT and peak detection algorithms to furnish bearings from RF signals. Systems can provide orientation, and trajectory information in real time via the robot operating framework.

A preferred embodiment provides a localization and mapping (SLAM) system that uses RF transceivers as landmarks for globally accurate trajectory estimation. The system can leverage WiFi transceivers, inertial odometry systems, cameras, and/or lidars on robots or other devices. The system can increase resource efficiency through reduced compute and memory consumption using WiFi landmarks, and can provide robot or device position, orientation, and trajectory information through the robot operating system (ROS).

A preferred system provides a SLAM toolbox for the ready integration of RF sensors into existing SLAM systems. The toolbox can measure coarse-grained WiFi signal strength (RSSI), and/or fine-grained WiFi channel state information (CSI), and/or other MAC-layer information, and can discover and place these Wifi devices on the map in real-time and provides the robot's position and orientation in a map while providing resource efficiency through reduced compute and memory consumption using WiFi landmarks. Calibration and processing algorithms to provide accurate bearing information for received WiFi signals, which algorithms can correct for hardware biases in the RF transceivers via processing that consists ofphase and magnitude corrections to the received WiFi data. FFT. SVD-FFT and peak detection algorithms can be used to furnish bearings from RF signals. Systems provide provide WiFi information, robot or other device position, orientation, and trajectory information in real time via the robot operating framework.

Preferred embodiments of the invention will now be discussed with respect to experiments and drawings. Broader aspects of the invention will be understood by artisans in view of the general knowledge in the art and the description of the experiments that follows.

### Landmark and Feature Identification

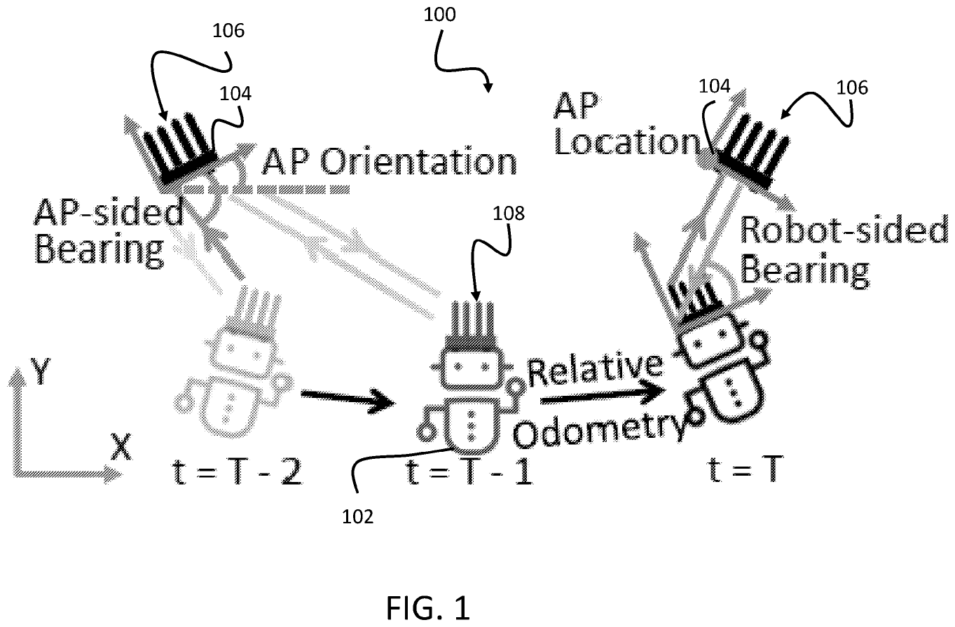

FIG. 1 is a block diagram of a SLAM system 100 of the invention including one or more robots 102 interacting with stationary transceivers 104 (e.g., WiFi APs) in an environment defined by the communication range of the transceiver as the robot 102 moves between three different locations. The robot 102 includes a sensor to measure relative odometry between consecutive robot poses. At each timestamp, the robot 102 pings an AP 104 and receives a pong reply. For each ping and pong transmission the AP-sided and Robot-sided bearing of the signal is computed, respectively. Ping and pong provide two distinct measurements/views and the robots 102 of the invention leverage an observation that bearing relative to an AP antenna array 106 and a robot antenna array 108 are distinct. Specifically, the ping enables determining the a pose of the robot 102 relative to the AP antenna array 106 and vice-versa with the pong, which are used as independent and distinct measurements, unlike prior RSSI systems that reciprocally transmit the same measurement in ping and pong. The present system preferably uses two-way bearings as unique measurements that can be used as the WiFi features for performing location and mapping.

### Feature Estimation and Characterization

A robot localization and navigation system of the invention then uses two-way bearing to estimate and characterize bearings relative to both the AP antenna array 106 and the robot antenna array 108. Wireless signals reflect off objects in the environment, making estimating the signal's bearing challenging but systems of the invention can characterize the noise variance of the bearing measurement with channel state information from commercial-off-the-shelf WiFi AP devices, while mitigating multi-path effects. Preferred methods model the noise distribution of these two-way bearing measurements and account for the noise distribution to conduct localization and mapping.

### Feature Integration

Preferred systems and method optimize measurements over multiple poses of the robot in real-time and back-propagate any errors in these two-way bearing measurements to optimize for the overall robot, and AP poses. A preferred embodiment utilizes the open-source Graph-SLAM library GTSAM [18], combining two-way bearing measurements along with the relative-pose measurements from odometry within a factor graph. By optimizing this factor graph, accurate pose estimates of the robot and the WiFi APs are obtained in the environment without a priori information.

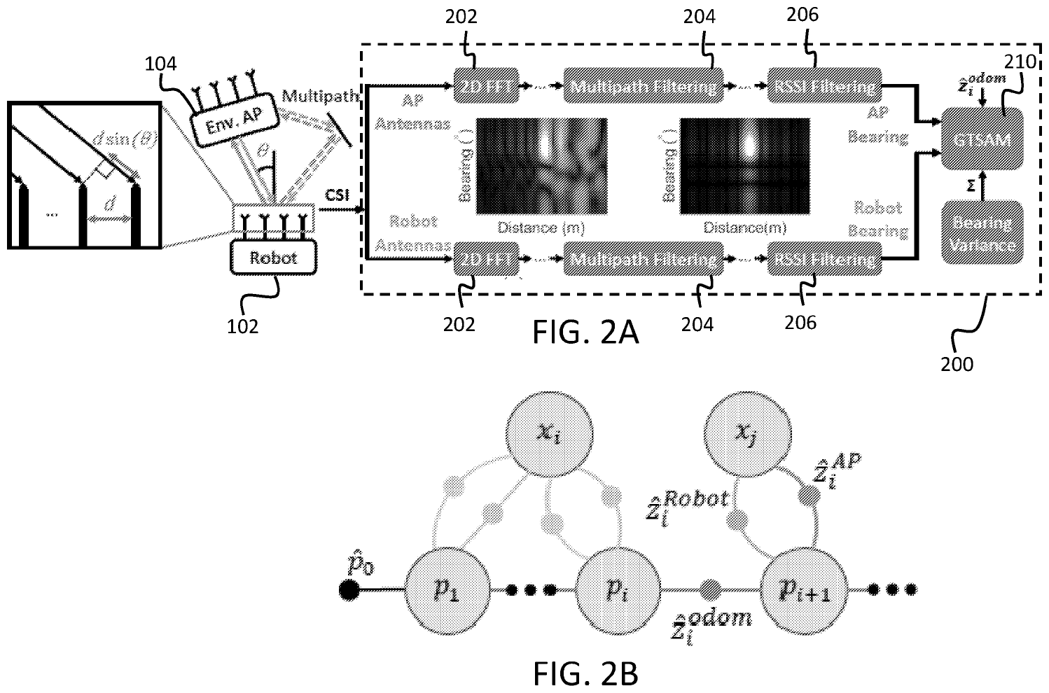

FIGS. 2A-2B WiFi Robot localization and navigation system.

FIGS. 2A-2B illustrate a preferred system 200 that is part of a robot 102 or another mobile device. The system 200 uses wireless channel (CSI) collected by the robot 102 via a ping and pong packet exchange with an AP 104. The system 200 processes both ping and pong via a Fast Fourier Transform (FFT) 202, multipath filtering 204 and RSI filtering 206 to remove multi-paths from these channels and effectively extract the bearing of the AP 104 and robot 102. The RSSI filtering 206 helps to remove outlier measurements. These 2-way bearing measurements, along with odometry measurements, and their measurement covariances, are fed into a SLAM framework 210. FIG. 2B shows the system Factor Graph, which is a visualization of factors and their connections once including the two-way bearing measurements as the WiFi features in a present implementation of GraphSLAM.

### Robust and Reliable WiFi Features to Leverage

The wireless propagation model employed for the WiFi 802.11ac protocol is a preferred communication medium. For simplicity, consider a single antenna at the AP 104 transmitter (Tx) and multi-antenna receiver (Rx) on the robot 102 as shown in FIG. 2A. A signal broadcast from the Tx is received at the Rx as a combination of multiple paths, including the ‘direct-path’ (solid line) and multiple reflected paths (dotted lines). These multiple reflections are termed as ‘multipath’. WiFi signals in 802.11ac employ OFDM modulation wherein a series of N narrowband frequencies, or ‘subcarriers’, are transmitted. So for the m^{th} antenna, nth subcarrier, and K multipath components, we model the raw CSI or wireless channel H^{m,n} as

$${H}^{m , n} = {\underbrace{[ {H}_{0}^{m , n} ( {z}_{0} , {l}_{0} )}}_{Direct Path} + {\underbrace{{\sum }_{i = 1}^{Λ} {H}_{i}^{m , n} ( {z}_{i} , {l}_{i} )}}_{Reflected Paths} ] {e}^{- j ϕ} \qquad ( 1 )$$

$${H}_{s}^{m , n} = {a}_{i} \cdot {e}^{- j ( 2 π \frac{{f}_{0}}{c} ( m - 1 ) {dsinz}_{i} )} {e}^{- j ( 2 π \frac{{f}_{n}}{c} {l}_{i} )}$$

with aᵢ as the amplitude, zᵢ and lᵢ as the angle of arrival and path length of each incoming signal at the robot, respectively. Furthermore, φ accounts for random phase offsets and timing offsets introduced due to lack of synchronization between the access points and the robot.

Rather than trying to use RSSI or CSI (channel state information), which require complex calculations, the preferred system in FIG. 2A extracts physical features from the raw CSI, preferably one or more of the angle of arrival (bearing, z₀) or path length (range, l₀) or velocity (v0), and the direct path, H₀. The robot 102 pings all APs 104 in an environment, which each pong the robot 102. The robot treats the ponging APs as fixed landmarks. The bearing can be measured independently each time a ping-pong occurs, as the robot 102 changes its pose and/or position. These two-way bearing measurements are unique from the robot to each AP and vice versa.

### Two-Way Bearing Estimation & Characterization

A 2D-FFT-based bearing estimation is used in the system 200 to avoid multi-path. Basic 2D-FFT bearing estimation is described in [4]. To simplify calculations, the system 200 makes a 2D-FFT-based bearing estimate while ignoring AWGN (additive white Gaussian noise) in the channel model. Given the raw CSI at the m^{th} receiver antenna at frequency fₙ as Ĥ^{m,n}, the system 200 generates a 2D ‘likelihood’ profile by taking the element-wise absolute of \hat{Λ}∈C^{|Z|×|L|}. This profile is generated by scanning over a set of possible bearings (Z={zᵢ|zₘᵢₙ<z<zₘₐₓ}) and distance measurements (L={l|lₘᵢₙ<l<Lₘₐₓ}). An element of this profile, Λᵢⱼ is generated using the following equation of the given bearing zᵢ and distance lⱼ.

$${α}_{m} ( z ) = {e}^{j \frac{2 π {f}_{0}}{c} ( m - 1 ) {dsinz}_{i}} ; {τ}_{n} ( l ) = {e}^{j \frac{2 π {f}_{n}}{c} {l}_{j}} \qquad ( 2 )$$

$${\hat{Λ}}_{ij} = {\sum }_{n = - \frac{N}{2}}^{\frac{N}{2} - 1} {\sum }_{m = 1}^{M} {\hat{H}}_{n , m} {\overbrace{{α}_{m} ( {z}_{i} )}}^{Bearing Phase} {\overbrace{{τ}_{n} ( {l}_{j} )}}^{ToF Phase} \qquad ( 3 )$$

given channel measurements across N frequency bins centered around center-frequency f₀ for M antennas on the receiver. Preferred embodiments identify the correct bearing for a given robot pose at a given WiFi anchor by computing the local maxima in Λ\hat{ } and choosing the maxima with the least lⱼ as indicating the direct path to the access point, i.e., the direct path's bearing (\hat{z}). The same estimation technique is can be simultaneously useed for bearings of both of the robot

$$( {\hat{z}}_{p}^{r obot} )$$

### and the AP

$$( {\hat{z}}_{p}^{A P} )$$

for a robot position p. After identification of the direct path bearing, a cleaned CSI is determined as Ĥ^{direct}=H₀(z₀=\hat{z}, l₀=0). The method sets l₀ to zero, which is permissible because it has no effect on bearing estimation.

Erroneous bearing estimates can be caused when a reflector blocks the direct path between the robot and an AP. In such an instance, though, the RSSI is low. The system filters the low RSSI via a threshold 206, and thus accounts for multipath and non-line-of-sight measurements to provide two-way measurements.

The bearing measurements are then incorporated into GraphSLAM or any other SLAM, which requires modeling the noise of the bearings. The invention provides a mathematical model to characterize the variance in the bearing errors due to the underlying AWGN in the CSI measurements. To model the variance, consider only the direct path's cleaned CSI matrix corrupted only with AWGN, Ĥ^{direct}∈C^{M×N} measured across M antennas and N subcarriers. From this CSI matrix, the direct path's likelihood profile \hat{Λ}^{direct} can be computed using Eq (2). Only the direct path component needs to be considered, as discussed above, so there will be a single maximum in \hat{Λ}^{direct} at the estimated bearing \hat{z} and path-length l₀=0. From this,

$$\hat{z} = arg {{max}_{{z}_{i}} ( {\hat{A}}_{i}^{direct} )}^{2} .$$

AWGN for elements in the matrix can be modeled as independent and identically distributed (IID) complex circularly symmetric additive Gaussian noise [26]. Accordingly, the distribution of \hat{Λ}ᵢ is complex Gaussian with the real and complex parts independently distributed as:

$${\hat{Λ}}_{i}^{direct} \sim 𝒩 ( {\sum }_{n = - \frac{- N}{2}}^{\frac{N}{2}} {α}_{m} ( {z}_{i} ) {H}_{n} , {σ}_{Λ , i}^{2} )$$

$$where$$

$${σ}_{Λ , i}^{2} = {\sum }_{n = - \frac{- N}{2}}^{\frac{Λ}{2}} {\vert {α}_{m} ( {z}_{i} ) \vert}^{2} {σ}^{2} = N {σ}^{2}$$

The squared magnitude of this complex Gaussian distribution yields a scaled non-central

$${x}_{2}^{2}$$

distribution [27] of (\hat{Λ}ᵢⱼ)=, where

$${κ}_{ij} \sim {χ}_{2}^{2} ( λ = {( {\sum }_{n = - \frac{- N}{2}}^{\frac{N}{2}} {α}_{n} ( {z}_{i} ) {H}_{n} )}^{2} )$$

where λ is the non-centrality parameter of the distribution. Next, ravel the two indices (i, j)→k and compute the probability of k being maximum index, kₘₐₓ, amongst all the candidate bearing values, which can be done according to the technique in [28]:

$$Pr ( {k}_{max} = k ) = {\int }_{0}^{∞} [ {{\prod }_{p = 1 , p \neq k}}^{\vert Z \vert \vert L \vert} {F}_{p} ( \frac{x}{{σ}_{Λ , p}^{2}} ) ] {f}_{k} ( \frac{x}{{σ}_{Λ , p}^{2}} ) dx$$

Fₖ and fₖ are the distribution and density functions of kₖ [29]. With this model, using the variance, σ², in the present CSI measurements, a theoretical variance estimate is obtained. This estimate has been verified by measuring the bearing errors observed in real-world experiments.

### Incorporating Wheel Odometry

Wheel odometry and gyroscope sensors provide relative pose measurements across time steps. The state space, S, is a set of robot poses over P time steps in the generated graph

$$S = \{ \vec{{p}_{l}} = ( {p}_{i}^{x} , {p}_{i}^{y} , {p}_{i}^{θ} ) ∈ SE ( 2 ) , Vi ∈ [ 1 , P ] \} ,$$

where each pᵢ belongs to the Special Euclidean group (SE(2)). The preferred relative pose measurement is zᵢ with a diagonal covariance matrix Σᵢ∈Σᵢ∈R³. The covariance matrix is estimated by empirically modeling the noise in the odometer and gyroscope beforehand. To define the measurement model \hat{z}^{odom}(⋅), two consecutive poses \vec{pᵢ} and \vec{p}ₗ₊₁ are used. The measurement model is:

$${\hat{z}}^{odom} ( {\vec{p}}_{i} , {\vec{p}}_{i + 1} ) = [ \begin{matrix}{R ( - {p}_{i}^{θ} ) [ {p}_{i + 1}^{x} - {p}_{i}^{x} , {p}_{i + 1}^{y} - {p}_{i}^{y} ]}^{T} \\ ( {p}_{i + 1}^{θ} - {p}_{i}^{θ} )\end{matrix} ]$$

R(⋅)∈S0(2) is the rotation matrix and the prediction function allows constraint of two consecutive robot poses via a between factor within GraphSLAM and defines and error function between the measurement and prediction

$${e}_{i}^{odom} ( {p}_{i} , {p}_{i + 1} ) = {z}_{i}^{odom} - {\hat{z}}_{i}^{odom} ( {p}_{i} , {p}_{I + 1} ) .$$

FIG. 2B shows that a Between Factor can incorporate \hat{z}^{odom}i. Construction of the factor graph can now be discussed.

First, poses of Q WiFi APs (x) are appended to the state space. The complete state space then becomes {pᵢ∀∈[1, P]}∪{xⱼ∀ⱼ∈[1, Q]}. This redefines the prediction function in (4) to obtain the angle subtended by access point xⱼ at robot pose pᵢ. Poses of the AP are thereby part of the optimization, account for error in its prediction:

$${\hat{z}}_{ij}^{robot} ( {p}_{i} , {x}_{j} ) = R ( - {p}_{i}^{θ} ) atan 2 ( {x}_{i}^{x} - {p}_{i}^{x} , {x}_{i}^{y} - {p}_{i}^{y} ) \qquad ( 4 )$$

The expression atan 2(⋅) is the “2-argument” inverse tangent function. The rotation

$$R ( - {p}_{i}^{Θ} )$$

bring the bearing of the access point into the local coordinate frame of the robot. This bearing measurement is made when the WiFi radio receives the ‘pong’ acknowledgement from the WiFi access points.

Feedback from the environment via ‘ping’ requests received at the access point is also incorporated. This measurement provides the robot's bearing in the AP's local frame of reference. Obtained is the bearing angle subtended in the local frame of reference at AP j when the robot is in the i^{th} position with the prediction function

$${z}_{ij}^{AP} ( {p}_{i} , {x}_{j} ) = R ( - {x}_{j}^{Θ} ) atan 2 ( {x}_{i}^{x} - {p}_{i}^{x} , {x}_{i}^{y} - {p}_{i}^{y} ) .$$

An AP height is also not known a priori, which could add to the complexity of the optimization. We have determined, however, that the bearings measured at the AP (and conversely at the robot) vary little with a change in the AP's height and negligibly affect the performance.

To anchor the robot to a fixed global frame of reference and align it with the ground truth trajectory and map generated by Cartographer [23], an initial prior is provided for a first pose of the robot when introduced into a WiFi environment. The initial prior is \hat{p}₀∈SE(2). The error in this initial factor is

$${e}_{0} = {[ [ {p}_{0}^{x} - {\hat{p}}_{0}^{x} , {p}_{0}^{y} - {\hat{p}}_{0}^{y} ] , abs ( {p}_{0}^{Θ} - {\hat{p}}_{0}^{θ} ) ]}^{T} .$$

With the factor graph constructed as shown in FIG. 2B, the complete optimization function is then defined as

$${S}_{opt} = arg {min}_{S} {\sum }_{i = 1}^{P} {\sum }_{j = 1}^{Q} ρ ( \frac{{( {e}_{ij}^{AP} )}^{2}}{{σ}^{AP}} ; c ) + {\sum }_{i = 1}^{P} {\sum }_{j = 1}^{Q} ρ ( \frac{{( {e}_{ij}^{Robot} )}^{2}}{{σ}^{AP}} ; c ) + {\sum }_{i = 1}^{P} {( {e}_{i}^{odom} )}^{T} - {\sum }_{i}^{- 1} {e}_{i}^{odom} . \qquad ( 5 )$$

The expression

$${e}_{ij}^{bearing} = {z}_{ij}^{bearing} = {\hat{z}}^{bearing} ( {p}_{i} , {x}_{i} ) .$$

### Resource-Efficient Dual-Graph Real-Time SLAM System

A preferred embodiment provides a dual-layered real-time SLAM system which overcomes the need of loop-closure detection making it resource efficient.

Preferred dual-graph embodiments provide a bifurcated design that leverages: (a) visual-inertial odometry (VIO) module providing real-time odometry measurements at a local scale, and (b) and a WiFi sensor module that performs online correction of global drifts. In addition, a visual-WiFi dual graph method is provided. Preferred embodiments utilize local odometry measurements (without global loop closure detection) extracted via inertial sensors and visual feature tracking. These local odometry measurements are then fused with WiFi measurements to track the WiFi landmarks in the environment in the dual graph method. This dual-graph method can be used with existing Visual/LiDAR (light detection and ranging) SLAM systems with a reduction in computation load and memory usage.

Preferred systems and methods further provide smart initialization of WiFi landmarks. To dynamically map WiFi landmarks when they are first observed, strength of the WiFi signal from the access point (AP) is determined. Next, the APs location close to the robot's current location is initialized when an inflection point is identified in the change of signal strength measured. The AP is thereby initiated close to its true location, which improves the convergence of the factor graph.

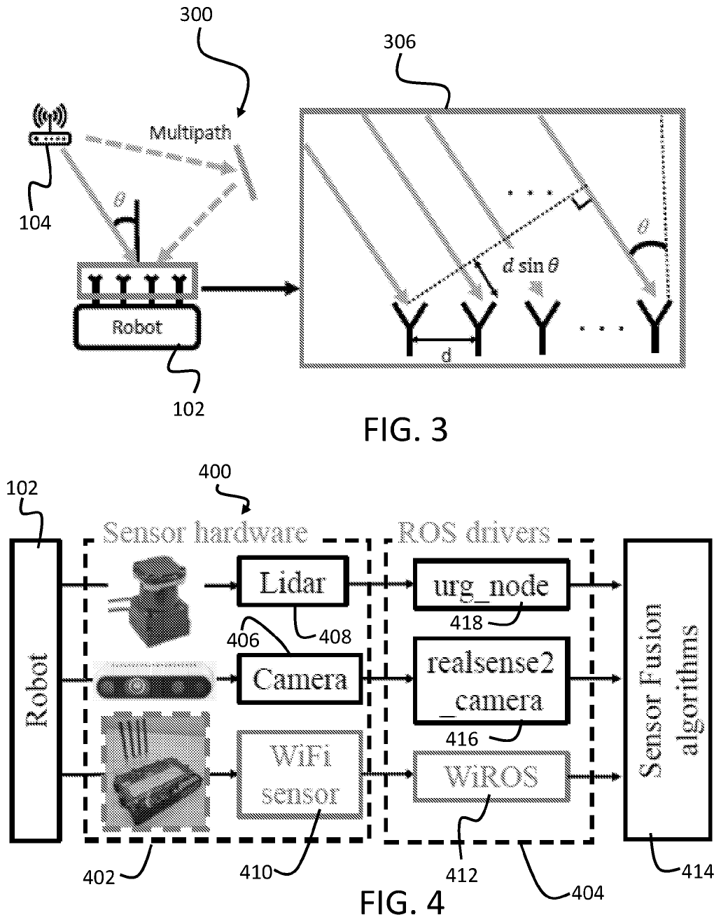

FIG. 3 shows a preferred dual-graph system 300 that collects WiFi bearings (θ) with a linear antenna array 306 with antenna separation d. The additional distance dsin (θ) travelled by the signals are exploited to estimate bearing.

A receiver on a robot 102 with an antenna array 306 measures, at time t, a complex-valued channel state information (CSI) describing the phase delay and attenuation across each of the M receiver antennas and N orthogonal frequencies as:

$${X}_{t}^{m , n} = {a}_{m , n} {e}^{j {ϕ}_{m} ( θ )} {e}^{- j ( 2 π {f}_{n} τ + ψ )} ; {X}_{t} ∈ {C}^{M \times N} {ϕ}_{m} ( θ ) = - \frac{2 π}{λ} md sin ( θ )$$

where, a_{m,n} is the attenuation; d is the antenna separation for the linear antenna array; fₙ is the orthogonal frequency; τ is the time-of-travel of the signal, which is often corrupted by the random ψ phase offset due to lack of transmitter/receiver clock synchronization; and ϕₘ(θ) is the additional phase accumulated at the m^{th} antenna due to the additional distance travelled by the signal. The various reflected paths impinging on the linear antenna array will add to each antenna in the array and across each frequency component in a similar manner.

The present dual graph antenna array system has reduced dimensionality compared to prior methods and still can reliably segregate the direct path signals from the clutter of the reflected paths. Specifically, from the channel model described in Spotfi [25], the largest eigenvector (Uₜ∈C^{M}) of

$${X}_{t} {X}_{t}^{H} ∈ {C}^{M \times M}$$

provides the largest contribution to the channel measured across the M receive antennas. However, this largest component can be corrupted by multipath. To remove the effect of multipath, we recognized that reflected paths are susceptible to small changes in the robot's position as opposed to the direct path which will arrive at a consistent bearing. A preferred method effectively averages-out the effects of multipath from a bearing estimation by combining measurements across time (over multiple packets) at intervals that can be predetermined. As an example, the largest eigenvector over most recent T measurements across the past 0.5 seconds is:

$${U}_{t} = λ ( {\sum }_{i = t - T}^{t} {X}_{i} {X}_{i}^{H} ) ,$$

Where λ(⋅) extracts the largest eigenvector, which is trivial to compute for our M×M autocorrelation matrix. From here, our direct path signal Uₜ can be mapped to a bearing by a coarse search over the space of possible bearings,

$${θ}^{*} = arg {max}_{θ ∈ [ - 90 ° , 90 ° ]} {\sum }_{i = 1}^{M} {ϕ}_{m} ( θ ) {U}_{t} ( m )$$

This Principle Component Analysis based Bearing (PCAB) provides similar bearing estimation performance to Spotfi [25] at just a fraction of the computation costs.

An RSSI filter of a predetermined value, e.g., RSSI below −65 dBm, is preferably used to filter out obstructed packets, as in the system 200 of FIG. 2A. These can arise where a large reflector blocks the direct path. In such circumstance, no information can be obtained about the direct path's bearing, and hence can lead to inconsistent bearing measurements. These non-line-of-sight (NLOS) scenarios are common and the RSSI filed avoids instability in the factor graph.

Differential phases measured with the antenna array are:

$${ϕ}_{m} ( θ ) = - \frac{2 π}{λ} ( {X}_{m} cos ( θ ) + {Y}_{m} sin ( θ ) ) ,$$

where the relative position of antenna m is (Xₘ, Yₘ) with respect to the first antenna.

### Dual-Graph Antenna Array Graph Building

A dual graph approach is used, where the drift-corrected poses from the WiFi graph can be utilized for globally consistent mapping. Incremental smoothing and mapping (iSAM [18]) are preferred to provide real-time pose estimates, while the present system and methods provide more accurate and real-time bearing estimation.

To build the WiFi graph, consider the state space at time t, Sₜ. It is a set of robot poses and access point locations over t time steps, in the graph, Sₜ={\vec{p}ᵢ∀i∈[1, t]}∪{\vec{x}ⱼ∀j∈[1, N]}, with the robot pose, \vec{p}ᵢ∈SE(3) and the N access points positions observed till time t, xᵢ∈R³. Odometry measurements are defined between poses \vec{p}ᵢ and \vec{p}ᵢ₊₁ at two consecutive time steps as:

$${\hat{z}}_{i}^{odom} ( {\vec{p}}_{i} , {\vec{p}}_{i + 1} ) = [ {R ( {p}_{i}^{q} )}^{- 1} {( {p}_{i + 1}^{t} - {p}_{i}^{t} )}^{T} {( {p}_{i + 1}^{t} ⊖ {p}_{i}^{t} )}_{[ 1 : 3 ]} ]$$

where, R(⋅)∈SO(3) is the rotation matrix corresponding to the given quaternion, ⊖ is the relative difference between two quaternions, and [1:3] chooses only the first three elements of the quaternion. Similarly, the bearing factors from AP j at robot position xᵢ is

$${z}_{ij}^{\hat{} Bearing} ( {p}_{i} , {x}_{j} ) ∈ {R}^{2} : {z}_{ij}^{\hat{} Bearing} ( {p}_{i} , {x}_{j} ) = Local ( TransformTo ( {x}_{j} , {p}_{i} ) , {p}_{i} ) = Local ( {[ cos ( ϕ ) cos ( θ ) , cos ( ϕ ) sin ( θ ) , sin ( ϕ ) ]}^{T} , {p}_{i} )$$

where, TransformTo (⋅) transforms the coordinates of the AP xⱼ to the coordinate system provided by the robot at pᵢ, in which the AP subtends an elevation angle of ϕ and an azimuth angle of θ. Local (⋅) projects this bearing measurement to the tangent plane defined by the current pose of the robot, pᵢ.

$${S}_{t}^{opt} = arg {min}_{{S}_{t}} {\sum }_{i \leq t} {\sum }_{j \leq N} ρ ( {( {e}_{ij}^{bearing} )}^{T} {\sum }_{bearing}^{- 1} {e}_{ij}^{bearing} ; c ) + {\sum }_{i ∈ {I}_{sub}} {( {e}_{i}^{odom} )}^{T} {\sum }_{odom}^{- 1} {e}_{i}^{odom} where {e}_{ij}^{odom} = {z}_{ij}^{Bearing} - {z}^{\hat{} Bearing} ( {p}_{i} , {x}_{j} )$$

is the bearing factor's error between robot and AP poses i and j;

$${e}_{ij}^{odom} ( {p}_{i} , {p}_{i + 1} ) = {z}_{i}^{odom} - {z}_{i}^{\hat{} odom} ( {p}_{i} , {p}_{i + 1} )$$

is the odom factor's error; ρ is the Huber cost function with parameter c [24]. Σ^{odom}∈R^{6×6} and Σ_{bearing}∈R^{2×2} are diagonal covariance matrices for odometry and bearing measurements, respectively. The bearing measured θ, the azimuth angle in the robot's local frame and once can assume that the elevation, ϕ, of the incoming signal is 0, hence

$${Z}_{ij}^{Bearing} = [ cos ( θ ) sin ( θ ) ] .$$

The elevation angle is set at 0 despite AP's placed at differing heights as it has little affect upon the azimuth bearing estimation, as discussed above.

### Factor Initialization

Each of the t robot positions and N AP positions are initialized prior to optimization. As discussed above, the robot positions can be initialized using the relative odometry measurements. These poses have accumulated drift over time, which the present method corrects.

In a preferred embodiment, RSSI is used in initialization to provide a general sense of proximity. The method preferably identifies the robot's position

$${p}_{ap - j}^{T} ∈ {R}^{3}$$

at which the j^{th} AP's RSSI measurement has an maxima inflection point among all current robot's poses pᵢ∀i∈[1, t], with the intuition that this is where the robot passed closest to the AP. Then initialize the j^{th} AP's pose xⱼ as

$${x}_{j} = {p}_{ap - j}^{T} + Δ ,$$

where Δ∈R³ is a small (≤0.1 m) random perturbation, which can be generated by a random number generator. This random perturbation is added to avoid indeterminacy with the optimizer. Finally, with the real-time, compute-efficient WiFi-bearing in hand, along with a reliable way to integrate these measurements with local odometry measurements, graph optimization can proceed iteratively with each time-step.

### Dual-Graph Antenna Array Experiments

The dual-graph SLAM method and system were tested on a ground robot TurtleBot2 platform equipped with a Hokuyo LiDAR and Intel Realsense D455 RGB-D camera with a built-in IMU for deploying cartographer and Kimera respectively. It was fitted with a 4 antenna WiFi radio. The robot was deployed in one large environment to collect data for demonstrating the present method compatibility with Kimera's VIO outputs (with loop-closures turned off), in addition to three open-sourced datasets to demonstrate deployability with LiDAR-inertial odometry (LIO) from Cartographer. Across these deployments, the robot traverses for an overall time of 108 minutes and a distance of 1625 m. The dual graph method achieves a median translation error of 70.8 cm and a median orientation error of 2.6°, on par with the state-of-the-art Kimera and Cartographer. While achieving a similar navigation accuracy: (a) the dual graph system only needs a total of 0.72 GB for a 25 minute run, wherein Kimera needs 2.82 GB, (b) the present system utilizes on average 0.72 fraction of single core of CPU whereas Cartographer utilizes over 3.2 cores of the CPU on average. This provides accurate, low-compute and low-memory SLAM.

### Wireless Calibration System for Robot Guidance

FIG. 4 shows a preferred system 400 for guidance of a robot 102 that includes sensor hardware 402 and robot operating system drivers 404. The sensor hardware 402 includes a conventional camera(s) 406 and Lidar(s) 408, integrated with additional features according to the invention of a WiFi sensor 410 and WiFi robot operating system 412, with integration of sensor data for localization and mapping by a sensor fusion algorithm 414 for enhanced guidance. The algorithm 414 accepts camera information from a standard camera ROS driver 416 and a standard Lidar driver 418 and enhances navigation via WiFi measurements. Preferred embodiments use the 802.11ac WiFi protocol, which provides 2× the sensing bandwidth to improve accuracy.

The sensor fusion algorithm 414 integrates and leverage Robot Operation System (ROS)-based time synchronization to extract physical parameters (angles of arrival and departure of the signal, angular positions of reflections in the environment) and aid robot operation. With the preferred embodiment, robots can measure the bearings of other robots or arbitrary fixed location transmitters (WiFi APs, laptops, phones, or IoT devices) that can service as anchor points for localization and navigation. This enables versatile localization and navigation with minimal cooperation from RF devices that are leveraged as anchor points.

Preferred embodiments provide calibration and set up to address the fact that commercial APs come with unique hardware biases, which can skew the signal measurements. These biases need to be measured a priori, and measurements must be calibrated to estimate various physical parameters, including the bearing of the transmitted signal. Past methods [36], [37], [38] have required disassembly of the device and manual measurement of these biases, severely reducing the tractability of a sensor platform. A present method provides a solution for automatically calibrating the phase offsets on-robot.

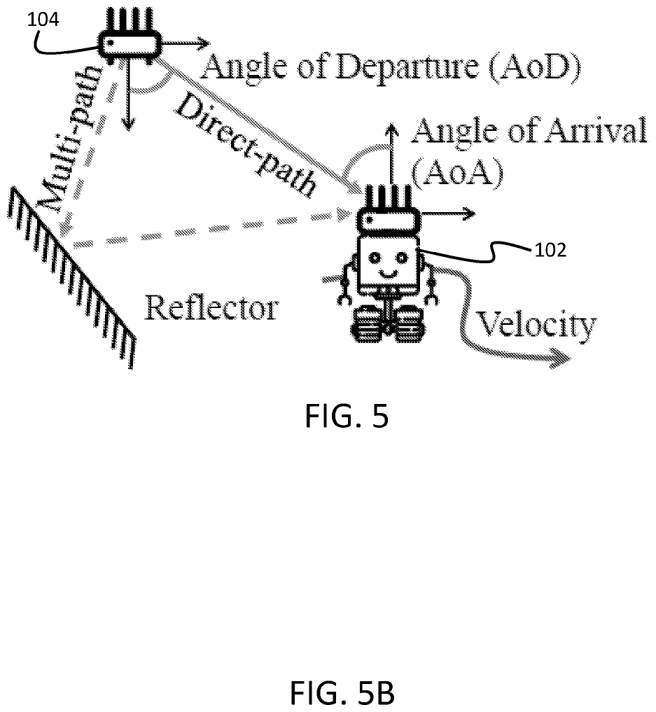

FIG. 5 shows a robot 102 and AP 104 in an environment with signal parameters measurable by CSI. The direct path's (solid line) and multi-path's (dotted line) angles of arrival and departure can be measured in the local coordinates of the APs 104. The robot's 102 velocity can also be measured.

### Standard Chipset Example

A system of the invention was demonstrated with an Asus RTAC86U, however, other chipsets can also be readily used. A preferred set up s
1. Compiles open-source ROS packages
2. Setups access point(s) by flashing firmware
3. Configures standard ROS parameters to be streamed with WiFi navigation measurements as ROS topics for robot navigation.

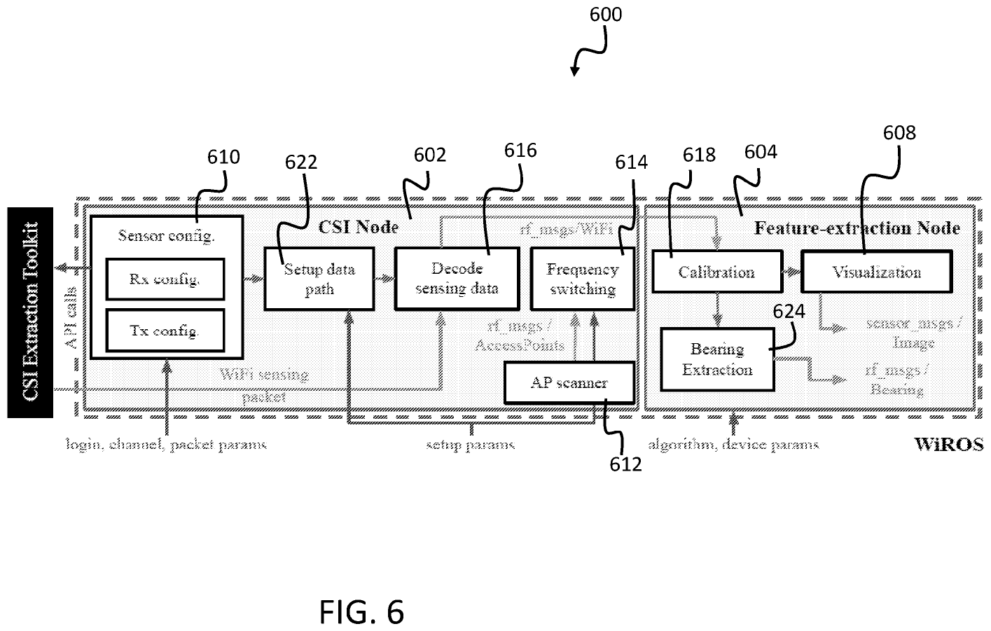

FIG. 6 shows a preferred system 600 with a CSI Node 602 and Feature-extraction Node 604 of the invention to extract raw WiFi measurements and to calibrate and integrate with CSI measurements for robot navigation. Because WiFi nodes can use different channels to avoid interference, a preferred feature extraction node 604 uses a periodic scan of channels to identify APs and channels being used when initializing in a new environment. The ROS node 604 estimates the angles of arrival and departure of a WiFi signal using state-of-the art techniques [25], [23]. A visualization module 608 provides visualizations of the received WiFi signal to aid debugging of the measured WiFi signals to verify if the measurement being used is clean enough to use or is too noisy such that it needs to be dropped/ignored. Providing the feature extraction node 604 allows out-of-the-box use of WiFi measurements for SLAM and other navigation purposes. The node can also be implemented to integrate other types of navigation measurements, e.g., Doppler estimation or time-of-flight measurements [39].

A transceiver 610 including a receiver and transmitter captures WiFi measurements from ambient WiFi signals in the configured frequency-channel and bandwidth. An AP scanner 612 and frequency switching 614 search for APs. These measurements will be available via a ROS topic provided by a decoder 616 through a WiFi-sensing ROS message, rf_msgs/Wifi to a calibration unit 618. A set-up data path unit 622 defines the path within the storage medium for the data to be written. A bearing extraction unit 624 integrates WiFi data with CSI data to provide corrected bearings for the robot, by utilizing the WiFi data to provide accurate RF bearing measurements for the robot.

RSSI and channel state information (CSI) are the two commonly used measurements and are leveraged by the decoder 616. RSSI, measured in dB, provides a rough estimate of the distance of an AP and can be used as a proxy to measure communication throughput, as a feature for improving SLAM performance and to map the transmitters coarsely. CSI provides more fine-grained information. It is a matrix of complex numbers indicating the received signal magnitude and phase across a set of transmitted frequencies and receiver antennas. The number of transmitted frequencies is controlled by the bandwidth (20, 40 or 80 Mhz), with the 80 MHz bandwidth only supported in the 802.11ac protocol. By default, for the Asus hardware, there are 4 receive antennas compared to 3 receive antennas commonly present in alternative systems [41], [42], [43]. The larger bandwidth and number of antennas provide more accurate sensing capabilities. Additionally, if a transmitter has multiple antennas configured, an additional dimension for the number of transmit antennas are present. However, these CSI measurements are challenging to visualize. To improve the tractability of WiFi sensors, preferred methods provide real-time visualizations via the visualization unit 608.

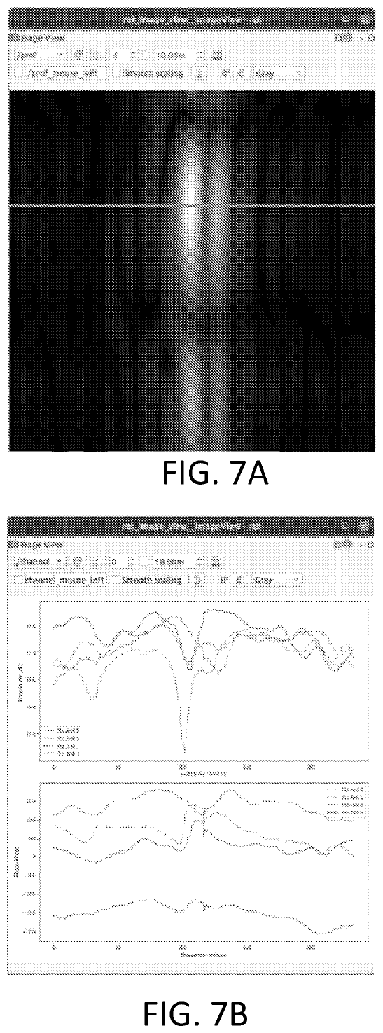

The feature extraction node 604 determines two important visualizations-a bearing range likelihood profile from the bearing extraction unit 624 and a magnitude-phase profile from the visualization unit 608. The bearing-range profile indicates the arrival of a WiFi signal from an AP via a straight-line direct path and via numerous reflected paths. In FIG. 7A, an example is given with the horizontal line indicting the strongest and direct path. The profile's peaks indicate the bearing of the transmitter (in the vertical axis) and the relative distances of the direct-path signal and its reflected path echoes. The magnitude-phase profile (FIG. 7B)) provides a less processed visualization of the CSI measurements, providing the magnitude (y-axis of top image) and phase (y-axis of bottom image) of the received signal in decibels and degrees, respectively, across various subcarrier frequencies (in the x-axis) and across the four receive antennas (as different lines). The visualizations in FIGS. 7A and 7B can be utilized to debug the wireless channel, check if all the receive antennas are performing equivalently or tune processing parameters like algorithms to leverage, and conduct time windowing for averaging or RSSI threshold. The visualizations can help an artisan to understand the accuracy of the parameters that can be set to filter out noisy vs clean measurements. If a current set of parameters does not fit their required level of accuracy within the measurements observed FIGS. 7A and 7B, one can tune the parameters to perform better filtering of the RF measurement.

FIG. 7A shows an example bearing-range likelihood profile, including a horizontal trace indicating the strongest received path, and hence the bearing of the signal. FIG. 7B shows a magnitude-phase profile, with the top plot showcasing the magnitude, and bottom plot the phases, across 4 receivers and 234 subcarrier frequencies. The example data reveals ease of use of the present invention for real-time data collection, processing, and debugging, improving conventional state-of-the-art systems that require cumbersome data file post-processing.

### Fast Calibration

Calibration can vary for different frequency-channels and is unique for each AP. Preferred calibration applies independent phase corrections across each antenna and frequency measurement. To compute this calibration, first, configure the transceiver 610 (on a robot) to a specific WiFi frequency-channel, and collect raw CSI measurements in a static predefined location in space where one or more APs are present. Instead of an ASUS WiFi sensor, a phone or laptop may be configured to transmit ‘ping’ packets. The purpose is to calibrate the WiFi sensor receiver. Run the robot in any pattern in relatively free space, within a 5 m radius of the AP, and collect the robot odometry measurements (vecr ₜ) as nav_msgs/Odometry and the WiFi measurements (Wₜ) as rfmsgs/Wifi from the CSI node. Note the location of the transmitter (\vec{t}) in the robot's generated map (often visible when using a LiDAR) and measure the relative antenna locations (\vec{a}ᵢ) on the receiver. This data can be input into the calibration unit 618 to generate the wireless calibration matrix.

Find a phase calibration matrix C

$$C = exp ( j Φ ) ∈ {C}^{4 \times {N}_{f}}$$

to calibrate the phase measurements across the 4 antennas and N_{f} frequencies, where Φ∈R^{4×N}^{_{f}}. Given a raw CSI measurement from the CSI Node, Wₜ∈C^{4×N}^{_{f}}, the calibration is applied as

$${W}_{t}^{cal} = C ⊙ {W}_{t}$$

where ⊙ is the Hadamard (element-wise) product.

Using the robot poses

$$( {\vec{r}}_{t} = ( {r}_{t}^{x} , {r}_{t}^{y} , {r}_{t}^{θ} ) ∈ SE ( 2 ) )$$

and transmitter location (\vec{t}∈R²), first compute the expected ground truth bearings (θₜ). These can then be converted to expected WiFi CSI measurements (W\hat{ }^{t}∈C^{4×N}^{_{f}}, implicitly assuming 4 receive antennas).

$${θ}_{t} = \frac{π}{2} - ( arctan ( \frac{{r}_{t}^{y} - {t}^{y}}{{r}_{t}^{x} - {t}^{x}} ) - {r}_{t}^{θ} ) {W}_{t}^{\hat{} i , j} = exp ( \frac{2 π j}{λ} [ cos ( {θ}_{t} ) , sin ( {θ}_{t} ) ] {\vec{a}}_{i} ) ∀ j ∈ [ 1 , {N}_{f} ] , ∀ i ∈ [ 1 , 4 ]$$

where, \vec{a}ᵢ is the relative location of the i^{th} antenna with respect to the first antenna; consequently, \vec{a}₁=\vec{0}. λ is the wavelength of the center frequency for the WiFi channel in consideration. Assuming a strong line-of-sight path signal is present, we can expect the phases

$$∠ {W}_{t} \approx ∠ {W}_{t}^{cal} .$$

The assumption is reasonable given that the calibration data is collected in a relatively open environment with no blockages to the signal. Consequently, we can suppress the phase difference induced by bearings as

$${W}_{t}^{sup} = {W}_{t} ⊙ conj ( W {\hat{}}_{t} )$$

This leaves the remaining calibration phase C in

$${W}_{t}^{sup} .$$

However, each WiFi measurement may have multiple reflected paths and hardware-centric Gaussian noise, which have not been adequately suppressed. However, we have two hints. One, reflections are inconsistent across different locations; two, averaging can suppress Gaussian noise. Hence, the best calibration estimate is the strongest remaining component in the suppressed

$${W}_{t}^{sup}$$

measurements. We can leverage Principle Component Analysis to extract this strongest component in the calibration data as

$${W}_{t}^{flat} = flatten ( {W}^{sup} ) t ) , {W}_{t}^{flat} ∈ {C}^{4 {N}_{f}} W = [ {W}_{0}^{flat} {W}_{1}^{flat} ⋯ {W}_{T}^{flat} ] U , S , V = SVD ( W ) {Φ}^{coarse} = ∠reshape ( {U}_{0} ) , {C}^{coarse} = exp ( j {Φ}^{coarse} )$$

where ‘flatten’ converts the matrix into a vector, SVD computes the full singular-value decomposition, ‘reshape’ converts the vector back into a matrix of the original dimensions, and ∠ computes the phase of the complex numbers. U₀ is the first and strongest principal component of W. However, as indicated, this calibration is a coarse estimate. The expectation is for the calibration matrix to consist of unit-norm elements, but the principle component, U₀, is a unit-norm vector, which does not preserve this property. This means we need to reproject C^{coarse} onto the space of calibrations. To find a valid calibration, C^{fine}, that is close to C^{coarse}, we note that C^{fine} must be orthogonal to the other vectors in U, so we try to find a fine-tuned calibration Φ^{fine} which has the lowest norm when it is projected onto U_{[1:]}.

$${Φ}^{fine} = {min}_{Φ} {‖ {U}_{[ 1 : ]}^{T} flatten ( exp ( j Φ ) ) ‖}_{2}^{2} {C}^{fine} = exp ( 1 j {Φ}^{fine} )$$

where U_{[1:]} is the orthogonal space, and we minimize for Φ by leveraging the Levenberg-Marquardt algorithm with an initialization of Φ^{coarse}. Via this fine-tuning process, the calibration unit 618 can recover the wireless phase calibration matrix C^{fine}.

The node 604 can include a library of CSI processing tools. Masurements from the CSI node 602 can be leveraged to measure signal path parameters like signal strength, angles of arrival or departure, the velocity of the transmitter, or locations of reflections in the environment. However, angular information can be readily measured from a single WiFi packet and provides a quick way to realize the advantages of WiFi measurements. Other processing tools that provide parameters like signal strength, angles of arrival or departure, the velocity of the transmitter, or locations of reflections in the environment can be used with a feature-extraction node of a preferred embodiment of the invention.

While preferred embodiments have been described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A robot or other device capable of movement, comprising a local position module and/or an RF communication module to conduct one or more of navigation, positioning, exploration, tracking, and mapping, the RF communication module being configured to communicate with RF anchor points and the local position module configured to provide relative odometry.

2. The robot or other device of claim 1, wherein the RF communication module is configured to process one or more of coarse-grained RF signal strength (RSSI), and/or fine-grained RF channel state information (CSI), and/or other MAC-layer information in communication with the RF anchor points for the one or more of navigation, positioning, exploration, tracking, and mapping.

3. The robot or other device of claim 1, wherein:
the RF communication module comprises a transceiver configured to communicate with fixed location RF anchor points;
the local position module comprises a relative odometry unit; and the robot or other device further comprises,
a localization and navigation system that conducts bearing measurements and/or distance measurements and/or velocity measurements between the robot and one or more of the RF anchor points and integrates these measurements with odometry measurements to navigate an environment.

4. The robot or other device of claim 3, wherein the localization and navigation system conducts mapping of an environment of the RF anchor points from the bearing, distance, velocity measurements using the RF measurements and the odometry measurements.

5. The robot or other device of claim 4, wherein the localization and navigation system comprises 2D-FFT bearing estimation, distance estimation, velocity estimation, multipath filtering and received signal strength (RSSI) threshold filtering for each of a robot and RF anchor point, and robot and anchor point bearings, distance or velocity are provided from the RSSI threshold to a mapping or navigation or localization module.

6. The robot or other device of claim 5, wherein the 2D-FFT ignores additive white Gaussian noise.

7. The robot or other device of claim 5, wherein the multipath filtering computes local maxima in ∀\hat{ } and chooses the maxima with the least lⱼ as indicating the direct path to the anchor point.

8. The robot or other device of claim 3, wherein the bearing measurements are conducted over multiple robot poses across time steps to conduct initial mapping of the anchor points.

9. The robot or other device of claim 3, wherein the localization and navigation system ignores anchor point height in conducting the bearing measurements.

10. The robot or other device of claim 3, wherein the bearing measurements are conducted by
ping and pong packet exchanges between the robot and the anchor points and time stamping packet exchanges;
processing the anchor points as an antenna array to conduct simultaneous localization and mapping of anchor points in the environment.

11. The robot or other device of claim 3, wherein the anchor points comprise RF access points.

12. The robot or other device of claim 3, wherein the relative odometry unit comprises Lidar (light detection and ranging), a camera, wheel odometry, intertial measurement unit, accelerometer, and/or gyroscope.

13. The robot or other device of claim 12, wherein the localization and navigation system comprises a sensor fusion unit that integrates measurements from the Lidar and camera with the bearing, range, and/or velocity measurements.

14. The robot or other device of claim 13, wherein the localization and navigation system extracts raw RF measurements to calibrate and integrate them with channel state information measurements for robot navigation.

15. The robot or other device of claim 14, wherein the localization and navigation conducts calibration via processing consist of Fast Fourier Transform, Singular Value Decomposition-Fast Fourier Transform and peak detection to determine bearings, velocity or distance from RF signals.

16. The robot or other device of claim 14, wherein the localization and navigation system determines a bearing-distance profile of the raw RF measurements and a magnitude-phase profile to determine a direct path to an anchor point.

17. The robot or other device of claim 3, wherein the bearing measurements are two-way bearing measurements and the localization and navigation system comprises a visualization module that analyzes a bearing distance profile from the two-way bearing measurements of direct and reflected paths and identifies a highest magnitude.

18. The robot or other device of claim 3, wherein the localization and navigation system comprises a visualization module that determines a phase of direct and reflected paths across multiple receive antennas and identifies the direct path from the phase.

19. A method for controlling a robot or other device capable of movement, the method comprising:
obtaining RF measurements from anchor points;
obtaining calibration for RF measurements;
obtaining local position information; and
using the RF measurements and local position information to to conduct one or more of navigation, positioning, exploration, tracking, and mapping.
